(19) United States
(12) Patent Application Publication
(10) Pub. No.: US 2024/0318988 A1
(43) Pub. Date: Sep. 26, 2024

(54) Sensor Mounting Station For Testing

(71) Applicant: Aptiv Technologies AG, Schaffhausen (CH)

(72) Inventors: Gian Marco Abbruzzese, Solingen (DE); Robik Edgarian, Wuppertal (DE)

(21) Appl. No.: 18/607,661

(22) Filed: Mar. 18, 2024

(30) Foreign Application Priority Data
Mar. 23, 2023 (EP) 23163731

(51) Int. Cl. G01D 11/30; G01S 7/40; H04N 17/00

(52) U.S. Cl. CPC G01D 11/30; G01S 7/40; H04N 17/002

(57) ABSTRACT

A sensor mounting station includes a sensor mount and a control device. The sensor mount is for removably mounting a sensor. The control device is configured to orient the sensor mount about a plurality of axes. The plurality of axes are constrained to pass through a common point in space corresponding to a middle point of the sensor when mounted to the sensor mount.

### CROSS-REFERENCE TO RELATED APPLICATIONS

This application claims priority to EP 23 163 731 filed Mar. 23, 2023. The entire disclosure of which is incorporated by reference.

### FIELD

The present disclosure relates to a sensor mounting station for testing, e.g. of vehicular sensors units such as radars and cameras.

### BACKGROUND

Modern vehicles which possess autonomous driving functionality require precise sensing of their immediate environment and beyond to be operated safely. This is often achieved by a variety of sensors, such as one or more radar sensors and/or cameras that are mounted to the vehicle body.

In order to locate a sensor in a test and/or calibration environment (e.g. a radar in an anechoic chamber or a camera relative to a target object), a robotic arm is usually employed so that the sensor's location in space is precisely controlled. However, such robotic solutions are typically expensive, large and heavy. As such, a robotic arm may not be feasible for use in a small radar chamber which is otherwise sufficient for testing purposes. Even small robotic arms may be too large for a desirable size of chamber and, in any event, are heavy/inconvenient to relocate.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to the above, a need has been identified to provide a mounting unit for sensor testing that does not rely on an expensive robot arm for spatial adjustments.

A first aspect is outlined according to claim 1 of the appended claims. Broadly, a sensor mounting station is provided, comprising: a sensor mounting device for mounting a sensor; wherein the sensor mounting device is movable about roll, yaw and pitch axes of movement (e.g. relative to a base), and each of the axes pass through a common point in space, corresponding to a middle point of the sensor when mounted to the sensor mounting device. Broadly, the mounting device is rotatable about at least one axis, ideally two axes, and most ideally three axes; i.e. roll, yaw and pitch axes.

In embodiments, each of the roll, yaw and pitch axes of movement are enabled by a respective rotational movement device, e.g. a roll device, a yaw device and a pitch device. Typically, a rotational movement device will be a two-part structure where the parts have circular, shaft or arcuate abutting surfaces that move relative to each other about a defined rotational axis. Indeed, in the disclosed embodiment the yaw, roll and pitch devices are constrained with axes that pass only through the common point, i.e. these axes are fixed relative to each other and no deviation is possible to ensure that articulation always occurs about the sensor middle point. This is distinct from, say, a robotic arm where an axis itself can be relocated. In embodiments, one or more of the movement devices is motorized, and moves in response to an electrical signal. Alternative forms may feature a manual adjustment.

In embodiments, the yaw device is actuated to rotate a horizontal yaw adjustable plate about a vertical axis. The term plate herein may be substituted for adaptor or functionally equivalent structure.

In embodiments, the roll device is located on a vertical extension of the yaw plate and actuated to rotate a roll adjustable plate about a first horizontal axis.

In embodiments, the pitch device is located on the roll plate and actuated to rotate the sensor mount device (or equivalent pitch adjustable plate) about a second horizontal axis, perpendicular to the first horizontal axis.

In embodiments, the sensor mounting device is configured to be further moveable in any or all of x, y and z directions relative to a base of the station, i.e. forward and back, left and right, up and down. In this way, the sensor mounting station is configured to enable movement of a sensor mounted to the device in six degrees of freedom, including three translational motions and three rotational motions. In one form, x, y, z movement is enabled by a base-proximate sub-station that is manually adjustable. The sub-station enables fine tuning in x, y, z direction, which affects the entire sensor mount structure above it.

In embodiments, a laser mounting device is provided, relative to the sensor mounting device, for mounting a laser to emit a laser beam in a direction passing through the common point. In this way, the sensor on the mounting station may be positioned relative to an object to be detected by the sensor, and the laser beam accurately indicates the facing direction of the sensor mount relative to the object to be detected. The beam serves as a laser pointer which is mounted behind the sensor bracket and extends through a hole (e.g. in a position equal to the center point of radar) for initial set up of the sensor mounting station. In one example, a radar sensor is then placed over hole in the bracket, and accurately faces the object to be sensed.

According to a method of use of the station, a laser is mounted to (or is part of) the laser mounting device, behind the sensor mounting device (prior to mounting of a sensor) relative to a frontal direction where an object to be detected is located. A laser beam is emitted through an opening of the sensor mounting device toward the object and axes of movement of the station are adjusted until the laser beam coincides with a desired point on the object to be detected. The laser beam may be turned off and/or the laser device removed. A sensor is then mounted to the sensor mounting device, accurately facing the direction of the object to be detected. A test step is then performed on the sensor.

The invention facilitates, in addition to mounting of the sensor, more flexibility and control for verification tests via the mount station as described herein. Particularly, the station provides an accurate spatial control of the sensor position. A particular form enables six degrees of freedom of movement, namely: forward and back, left and right, up and down, roll, yaw and pitch; of a sensor when mounted to the sensor mount device. The invention may be described in general terms as a “six axes sensor motion station” because it enables complete freedom of movement of a sensor unit relative to a base fixture in a testing chamber.

Accordingly, the problems of weight, control and cost of a robotic arm are solved by an assembly of parts that can be made from light and compact materials such as aluminum and/or plastic. It may be possible to automate, by servo motors or the like, relative movement of the one or more parts of the mounting station and optionally implement manual adjustment of other parts.

In general, the main purpose of the invention is enabling accurate positioning of a sensor (e.g. radar or camera) relative to a target (such as a corner reflector) in a testing area. The sensor mounting station finds particular application in small radar chambers. The invention enables articulation of a sensor about every axis, analogous to a robot arm, and with comparable or enhanced precision. In a various form, the station has motorized control of roll, pitch and yaw movement of the sensor mount, and a manually controlled x, y, z movement sub-station at a base of the unit.

The sensor testing station may be in the form of an articulated platform that also incorporates an x, y, z adjustable block at a base thereof. The articulated platform may be adjusted by two step motors, each enabling rotational movement about axes in respective perpendicular planes (for roll and yaw movement of respective roll and yaw plates) and a goniometer for angular adjustment of pitch of the sensor mounting device (or pitch adjustable plate).

The sensor mount or adaptor may include additional mounting features for supporting (e.g. connecting and/or clipping to) the sensor. A laser generating device may be incorporated with or attachable to the sensor mount.

The invention may be integrated or combined with a further mounting device for mounting a vehicle part for independent movement relative to the sensor on the sensor mounting station, where the independent relative movement of the vehicle part comprises at least three degrees of freedom selected from: forward and back, left and right, up and down, roll, yaw and pitch. A combined apparatus of this type may be used in the context of testing properties of a radar sensor when the vehicle part is disposed between it and a radar target simulator.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

Illustrative embodiments will now be described with reference to the accompanying drawings.

FIG. 1 illustrates a front overview of a sensor mounting station according to the invention;

FIG. 2 illustrates a rear overview of the sensor mounting station;

FIG. 3 illustrates an overview of a yaw control device and x, y, z direction control device;

FIG. 4 illustrates an overview of a roll control device and pitch control device;

FIG. 5 illustrates a front overview of the sensor mounting station being adjusted about a yaw axis;

FIG. 6 illustrates a front overview of the sensor mounting station being adjusted about a roll axis;

FIG. 7 illustrates a front overview of the sensor mounting station being adjusted about a pitch axis;

FIG. 8 illustrates a partial front overview of a sensor mount device, with sensor removed;

FIG. 9 illustrates a partial front overview where the sensor mount device has been removed; and

FIG. 10 illustrates an exploded overview of the sensor mounting station.

In the drawings, reference numbers may be reused to identify similar and/or identical elements.

### DETAILED DESCRIPTION

The following description presents various embodiments and, together with the drawings, serves to explain principles of the invention. However, the scope of the invention is not intended to be limited to the precise details of the embodiments or exact adherence with all features and/or method steps, since variations will be apparent to a skilled person and are deemed also to be covered by the description. Terms for components used herein should be given a broad interpretation that also encompasses equivalent functions and features. In some cases, several alternative terms (synonyms) for structural features have been provided but such terms are not intended to be exhaustive. Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “sideways”, “upper” and “lower” are used for convenience of explanation usually with reference to the orientation shown in illustrations and are not intended to be ultimately limiting if an equivalent function can be achieved with an alternative dimension and/or direction. Indeed, in the present case a term such as “horizontal” axis or “vertical” axis can be affected by the orientation imposed on the sensor mounting structure. Therefore, all directional terms are relative to each other.

The description herein refers to embodiments with particular combinations of steps or features, however, it is envisaged that further combinations and cross-combinations of compatible steps or features between embodiments will be possible. Indeed, isolated features may function independently as an invention from other features and not necessarily require implementation as a complete combination.

It will be understood that the illustrated embodiments show applications only for the purposes of explanation. In practice, the invention may be applied to many different configurations, where the embodiment is straightforward for those skilled in the art to implement.

A sensor mounting station according to an embodiment is illustrated by the drawing figures. The station is a “test rig”, generally denoted 10, to be associated with a sensor S which is removably attachable to a sensor mount 12. The sensor S is to be spatially fixed in a position relative to a target object (not shown).

The sensor S is supported at a point in space and adapted for adjustable movement relative to a base plate 13 by an x, y, z linear/translational adjustment block/sub-station 14, and three rotational adjustment means, namely a yaw control device 15, a roll control device 16 and a pitch control device 17. Base 13 may be secured to a ground surface by the illustrated fixing holes at a specified distance from a target object in a testing chamber.

In the illustrated form, block 14 is manually adjustable by various slidable inter-engaging tracks to move an upper platform 18 in x, y and/or z linear directions, relative to the base plate 13 upon which it is mounted. Alternative forms may implement electronic control of directional block 14. As such, it will be apparent that all components supported above platform 18, including sensor S, are correspondingly movable translated linearly in front-to-back, side-to-side and up and down directions.

Platform 18 supports the yaw control device 15 which, in the illustrated form, comprises a rotating step motor 20 configured to pivot/rotate an angle plate 19 about a vertical yaw axis Y. The motor 20 accurately actuates a circular platform/dial 21, affixed to angle plate 19. Degrees to measure movement may be marked/registered on the edge of dial 21.

An upstanding extension/frame 22 extends vertically from an edge of the horizontal base of angle plate 19 and provides support for the upper rotational devices 16, 17 and, ultimately, sensor S. As such, all components “upstream” of yaw control device 15 are reoriented about axis Y when a yaw adjustment is made.

Roll control device 16 is affixed directly to frame 22 as seen in FIG. 2, with detail of the device best seen in FIG. 4. Particularly, roll control device 16 implements a smaller step motor 23 for rotationally actuating an intermediate roll plate 28 which in turn mounts the pitch device 17. In this way the rotational orientation of the pitch control device 17 (i.e. a goniometer) can be adjusted about a horizontal roll axis R. All upstream components, including the sensor S, are thus roll adjustable.

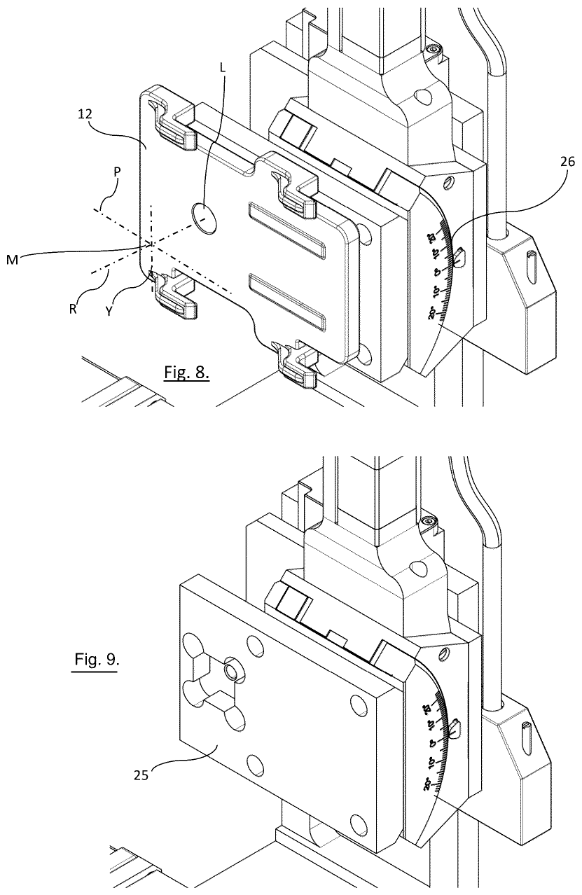

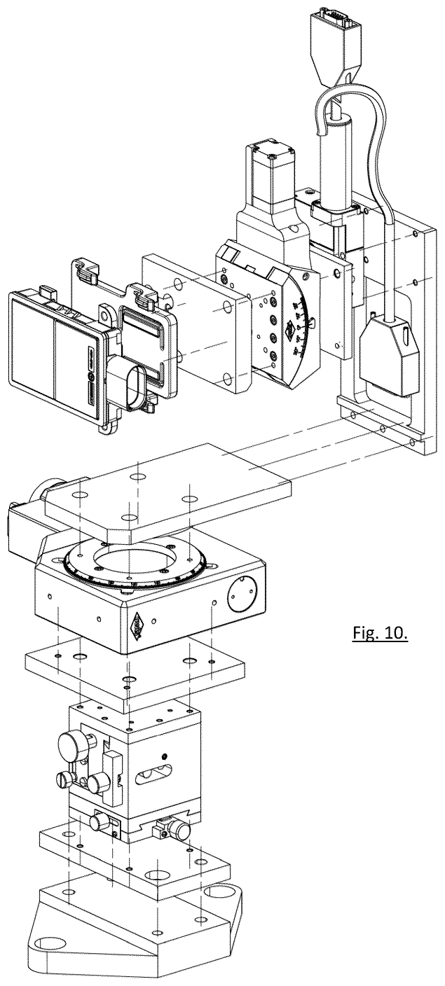

The pitch control device 17, also best visible in FIG. 4, includes a front surface (visible in FIG. 10) that is affixable to the sensor, such as via sensor mount 12 or an intermediate pitch plate 25 (visible in FIGS. 9 and 10), and a convex rear surface movably coupled to a concave receiving surface thereby cooperating to tilt the front surface about a horizontal pitch axis P. An arcuate track 26 is visible in FIGS. 4, 8 and 9 and surface markings may indicate the degree of angular displacement as pitch is adjusted. Pitch movement is actuated by a motor 27 controlled electronically along with step motors 20 and 23.

Therefore, according to the foregoing, the motion station system has four main components for executing its function, namely an X-Y-Z-station 14, a goniometer (pitch device 17), one small rotating step motor roll device 16 and one bigger rotating step motor yaw device 15. These moving part components are assembled together by adaptors/mounts, e.g. made out of aluminum.

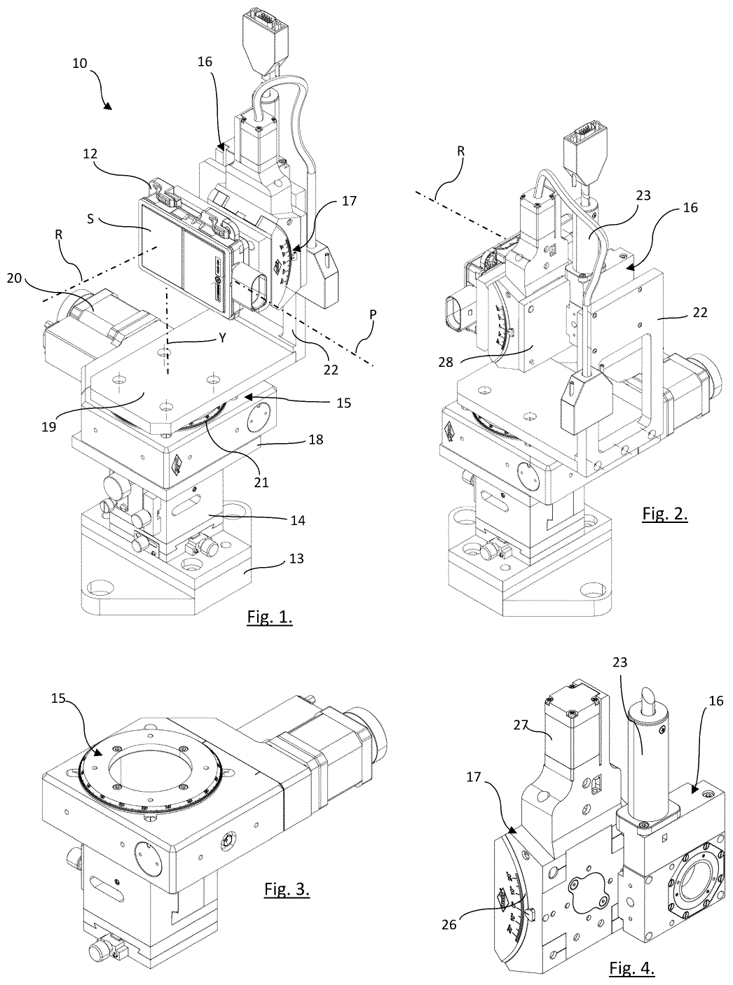

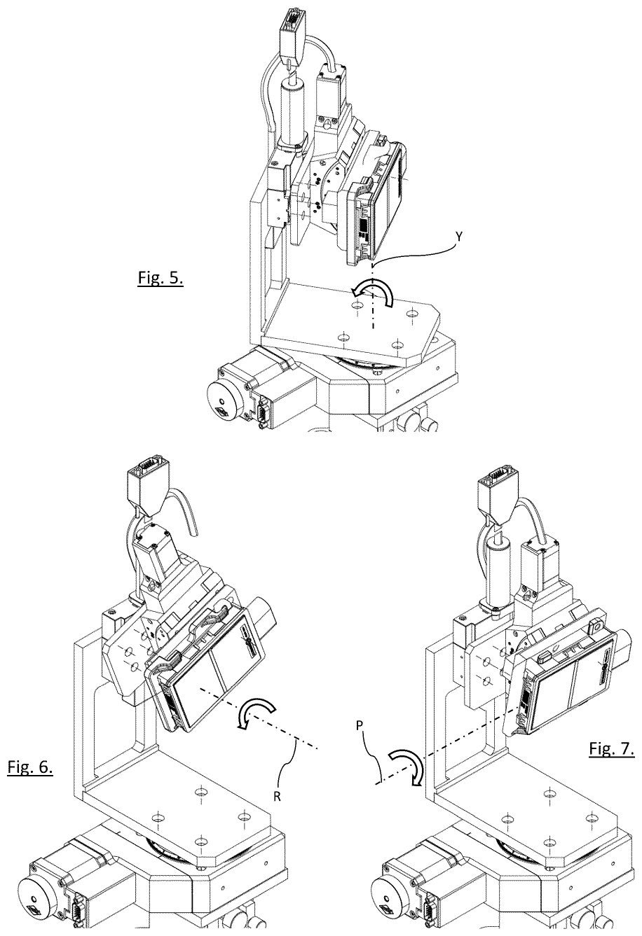

It is particularly apparent according to FIG. 1 that sensor mount 12 supports a sensor S (e.g. radar, camera) to ensure that every tilt/rotation axis (Y, R, P) goes through a common point within the sensor S, e.g. that corresponds to an antenna middle point and creates a “universal” pivot point about which all spatial adjustment of the sensor takes place. This positioning is enabled by the fitting bracket/mount 12 itself or, in principle, a sensor may be directly fitted to the locating holes visible in the pitch control device 17 (see FIG. 4) or an equivalent mounting plate.

In this way, the sensor position is precisely controllable with respect to a distant object to be detected, not illustrated.

In order to assist with positioning the sensor S relative to a distant object, a laser emitting device may be mounted to direct a laser beam to point forwardly away from station 10 toward an object in a test environment. The characteristic dot of light of the laser is able to ensure that the sensor will point directly at the distant object.

In one implementation, a laser emitting device is attachable behind sensor mount 12, e.g. to plate 25 (see FIGS. 8 and 9), before the sensor S is secured in place, such that a laser beam passes through a hole L corresponding to the middle point M of the sensor. With reference to FIG. 1, the emitted laser beam will be directed along axis R, but will be angularly displaced from this position as/if pitch is adjusted.

The laser emitting device can be removed when the sensor S is in place because, in the above implementation, the laser beam cannot pass through the sensor in use.

An alternative configuration is possible where a mounting bracket projecting forward of the sensor/mount 12 could suspend a laser pointer to emit a laser beam corresponding to the middle point of the sensor. However, the laser device should be removed prior to use of the sensor to avoid interfering with its detection signal.

The embodiment of sensor mounting station described above and shown in the drawing figures, particularly the exploded view of FIG. 10, is comprised of two main sub-stations, i.e. a base unit which provides x, y, z translational movement and a second sub-station mounted upon the base unit which is a combination of integrated yaw, roll and pitch devices which provide rotational movement about an intersection of three axes.

So long as the station can maintain an intersection of yaw, roll and pitch rotational axes corresponding to the middle point of the sensor, alternative forms of the invention may be possible where the sequence of yaw, roll and pitch devices are re-ordered. For example, pitch adjustment upstream of yaw and roll or any combination thereof.

However, it is not envisaged to provide x, y and/or z translational adjustment associated directly at the sensor mount or other rotational devices because this would move the rotational axes Y, R, P out of alignment so there is no common intersection point.

The sensor mounting station may be used according to an example method, e.g. wherein a laser device is mounted to or proximate the sensor mount and a laser beam is emitted for pointing toward an object to be sensed. Due to its mounting at a position corresponding to the sensor, the laser beam will point in a direction normal to the sensor emitter, i.e. the same as a detection direction. Depending on where the laser initially points, indicated by the distinctive “red dot” of the laser, the sensor mount can be adjusted for yaw, roll and/or pitch orientation, optionally along with translational adjustment, until the laser beam coincides with the object to be sensed. The laser device may be removed and/or turned off followed by mounting a sensor to the sensor mounting station in the position determined by the laser device. Functions of the sensor can then be tested relative to the object to be sensed.

By way of summary, a sensor mounting station includes a sensor mount for removably mounting a sensor. The sensor/mount is spatially adjustable by a yaw control, a roll control and a pitch control, which may be achieved by one or more separate devices. Such rotational adjustment is optionally combined with an x, y, z direction adjustment. Each of the respective yaw, roll and pitch rotational axes pass through a common point in space, corresponding to a middle point of the sensor. In one form, a laser device is mountable to the sensor mount to point a laser beam in a direction corresponding to a middle point sensing direction normal to the sensor.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A sensor mounting station comprising:
a sensor mount for removably mounting a sensor; and
a control device configured to orient the sensor mount about a plurality of axes,
wherein the plurality of axes are constrained to pass through a common point in space corresponding to a middle point of the sensor when mounted to the sensor mount.

2. The sensor mounting station of claim 1 wherein the control device is configured to rotate the sensor mount about at least two of: a yaw axis, a roll axis, and a pitch axis.

3. The sensor mounting station of claim 1 wherein the control device includes separate devices for orienting the sensor mount about a yaw axis, a roll axis, and/or a pitch axis.

4. The sensor mounting station of claim 1 further comprising a translational displacement device.

5. The sensor mounting station of claim 4 wherein the translational displacement device is configured for movement in x, y, and/or z directions.

6. The sensor mounting station of claim 4 wherein the translational displacement device is located proximate a base of the sensor mounting station and configured to provide translational displacement to the control device.

7. The sensor mounting station of claim 6 wherein the translational displacement device includes a platform, configured for translational movement, for coupling to the control device.

8. The sensor mounting station of claim 2 wherein:
the control device includes a yaw control device configured to rotate a support element about the yaw axis, and
the support element is connectable to a roll control device and/or a pitch control device.

9. The sensor mounting station of claim 8 wherein:
the roll control device is configured to rotate a support element about the roll axis, and
the support element is connectable to the pitch control device and/or the yaw control device.

10. The sensor mounting station of claim 9 wherein:
the pitch control device is configured to rotate a support element about the pitch axis, and
the support element is (i) connectable to the sensor mount, (ii) integrated with the sensor mount, (iii) connectable to the roll control device, or (iv) connectable to the yaw control device.

11. The sensor mounting station of claim 1 further comprising a laser device mount.

12. The sensor mounting station of claim 1 wherein the sensor mount is configured to function as a laser device mount such that a laser beam can be emitted normal to a surface of the sensor for pointing at an object to be sensed by the sensor.

13. The sensor mounting station of claim 1 wherein the control device is motorized for incremental angular displacement about the plurality of axes.

14. A method for mounting a sensor for testing, the method comprising:
mounting the sensor to a sensor mounting station, wherein:
the sensor mounting station includes:
a sensor mount for removably mounting the sensor, and
a control device configured to orient the sensor mount about a plurality of axes, and
the plurality of axes are constrained to pass through a common point in space corresponding to a middle point of the sensor when mounted to the sensor mount;
facing the sensor in a direction of a target object;
activating the sensor to detect the target object; and
collecting data corresponding to detection of the target object and using the collected data to analyze performance of the sensor.

15. The method of claim 14 wherein the direction of the target object is predetermined by (i) mounting a laser device to or proximate the sensor mount, (ii) emitting a laser beam coincident with a middle point of the sensor to be mounted, and (iii) adjusting yaw, roll, and/or pitch orientation of the sensor mount until the laser beam coincides with the target object to be sensed.

16. The method of claim 15 including further adjusting an x, y, and/or z linear displacement direction of the sensor mount until the laser beam coincides with the target object to be sensed.
